(19) United States
(12) Patent Application Publication
(10) Pub. No.: US 2018/0027800 A1
(43) Pub. Date: Feb. 1, 2018

(54) Tree Stand with Mechanical Assemblage and Clamp System

(71) Applicant: Michael Bryan Dyer, Gainesboro, TN (US)

(72) Inventor: Michael Bryan Dyer, Gainesboro, TN (US)

(21) Appl. No.: 15/662,207

(22) Filed: Jul. 27, 2017

Related U.S. Application Data
(60) Provisional application No. 62/367,525, filed on Jul. 27, 2016.

(51) Int. Cl. A01M 31/02

(52) U.S. Cl. CPC A01M 31/02

(57) ABSTRACT

The present invention concerns a tree stand, specifically a ladder stand that includes a novel mechanism for anchoring to a tree at a platform level. The invention employs a mechanical assemblage and clamp system to lock in place against a tree. The mechanical features of the invention can be activated from a ground level, meaning that a user can safely secure the ladder stand before ascending to an elevated position.

### CROSS-REFERENCE TO RELATED APPLICATIONS

This application claims priority to U.S. Provisional Patent Application Ser. No. 62/367,525 titled “A strapless ladder stand that doesn't require a strap to hold it to the tree. It uses arms and tension to hold stand,” filed Jul. 27, 2016, which is incorporated by reference.

### BACKGROUND OF THE INVENTION

The present invention is directed to a hunting and recreation stand, and more particularly one that features a mechanical assemblage and clamp system for increased safety and performance in the field.

Tree stands, also known as deer stands, feature open or closed platforms, and often seats, and are used primarily for hunting. These stands are secured to trees and allow users to obtain elevated vantage points for observing or targeting ground-based prey. Different types of tree stands include climbing stands, ladder stands, hanging stands, and box stands. Ladder stands usually consist of ladders, platforms and seats fixed together and attached to smooth tree trunks by straps. Ladder stands are usually permanently placed in regular hunting locations. Climbing stands are lightweight, portable stands that ideal for treks or variability. The publication “How to Use a Climbing Tree Stand” (Bow Hunting, www.bowhunting.com/bowhunt101/how-to-use-climbing-treestand) describes the process for ascending a tree with a common climbing stand. Hanging stands are permanent or long-term platforms that are first secured to a tree by means of a ladder or temporary support that may be removed once that hanging stand is secured to the tree.

Hunting from elevated stands can be dangerous. About twenty percent of tree stand users fall from their stands in a given year (Smith, J L et al. “Injuries Due to Falls from Hunters' Tree Stands in Pennsylvania.” Am J Prev Med 2009; 37(5): 433-36). One out of every ten tree-stand users are injured every year, with three-quarters of those injuries resulting from use of fixed position or climbing stands. (Terry, J et al. “Epidemiology of tree stand-related injuries in the United States from 2000 to 2007.” J. Trauma 2010; 68: 712-715. Web. 25 July 2017). A study conducted by the University of Rochester Medical Center reviewing over fifty tree-stand related injuries from 2003 to 2011 documented an average fall of nearly 20 feet, with over half of patients suffering spinal fractures (Pierre, Clifford A et al. “Tree Stand Falls: A Persistent Cause of Neurological Injury in Hunting.” World Journal of Clinical Cases: WJCC 2.8 (2014): 345-350. PMC. Web. 25 Jul. 2017). Similar studies have identified long delays in initial treatment, with some patients experiencing complications from hypothermia (Fayssoux, R S et al. “Spinal Injuries after Falls from Hunting Tree Stands. Spine J. 2008 May-June; 8(3): 522-8. Web. 25 Jul. 2017).

Tree-stand injuries occur among all stand users, though ladder stands are associated with fewer injury sustaining falls (The International Hunter Education Association. Survey of Hunters in North Carolina and Vermont: Safety Issues Related to Hunting in Tree Stands, August 2002). The present invention offers improvements upon ladder stand designs.

U.S. Pat. No. 3,336,999 issued to Mcswain is directed to a tree stand ladder with a toggle operated tree clamp.

U.S. Pat. No. 4,100,999 issued to Conner is directed to a tree stand ladder attachment with seat, foot rest, and gripping device.

U.S. Pat. No. 5,279,390 issued to Phillips is directed to a tree stand platform with spike bar and tightening cables.

U.S. Pat. No. 6,336,520 issued to Amacker is directed to a tree stand platform with backside jack plate.

U.S. Pub. No. 20170142959 A1 attributable to Berkbuegler is directed to a ladder tree stand with pivoting jaw assembly.

U.S. Pub. No. 20110209944 A1 attributable to Humphrey and Parker is directed to a ladder tree stand with clamping system operable by a cable tensioning device.

The X-Stand TreeStands jaw system features a ladder stand, tree clamp, stabilizers, and ground level tightening system (www.x-stand.com/wp -content/uploads/2015/05/FINAL_jaw_blueprint_8_5x11.pdf).

### BRIEF SUMMARY OF THE INVENTION

In a preferred embodiment of the present invention, a tree stand platform which can attach to and form part of a ladder stand, features a landing, seat, and mechanical system for anchoring to a tree.

### BRIEF DESCRIPTION OF THE SEVERAL VIEWS OF THE DRAWING

The present invention will be better understood from the following detailed description with reference to the following drawings:

FIG. 1 is a side view of the tree stand emphasizing the uppermost attachment portion of the stand secured to a tree.

FIG. 2 is a front view of the tree stand emphasizing the uppermost attachment portion of the stand secured to a tree.

FIG. 3 is a bottom plan view of the platform component of the tree stand showing the mechanical assemblage and clamp system in a closed position around a lesser diameter tree trunk.

FIG. 4A is a bottom plan view of the platform component of the tree stand showing the mechanical assemblage and clamp system in a closed position around a greater diameter tree trunk.

FIG. 4B is a bottom plan view of the platform component of the tree stand showing the mechanical assemblage and clamp system in a closed position around a larger diameter tree trunk.

FIG. 6 is a side elevation view of the tree stand as attached to a ladder and secured to a tree.

FIG. 7 is a perspective view of the underside of the platform component of the tree stand emphasizing the mechanical assemblage and clamp system.

FIG. 8 is a perspective view of the underside of the platform component of the tree stand emphasizing the mechanical assemblage and clamp system under manipulation by a laterally extended rod.

FIG. 9 is a perspective view of the underside of the platform component of the tree stand emphasizing the mechanical assemblage and clamp system under manipulation by a vertically extended rod.

### DETAILED DESCRIPTION OF THE INVENTION

The unique attributes of the tree stand with mechanical assemblage and clamp system are presented in detailed embodiments below. Chiefly, the new tree stand described in this application is designed to mitigate potential injury by establishing a secure connection between ladder and tree before an attempted ascent to a hunting or observing position. The embodiments below are presented as designed or tested illustrations only, and are not meant to limit the tree stand from extension to alternative, similar embodiments.

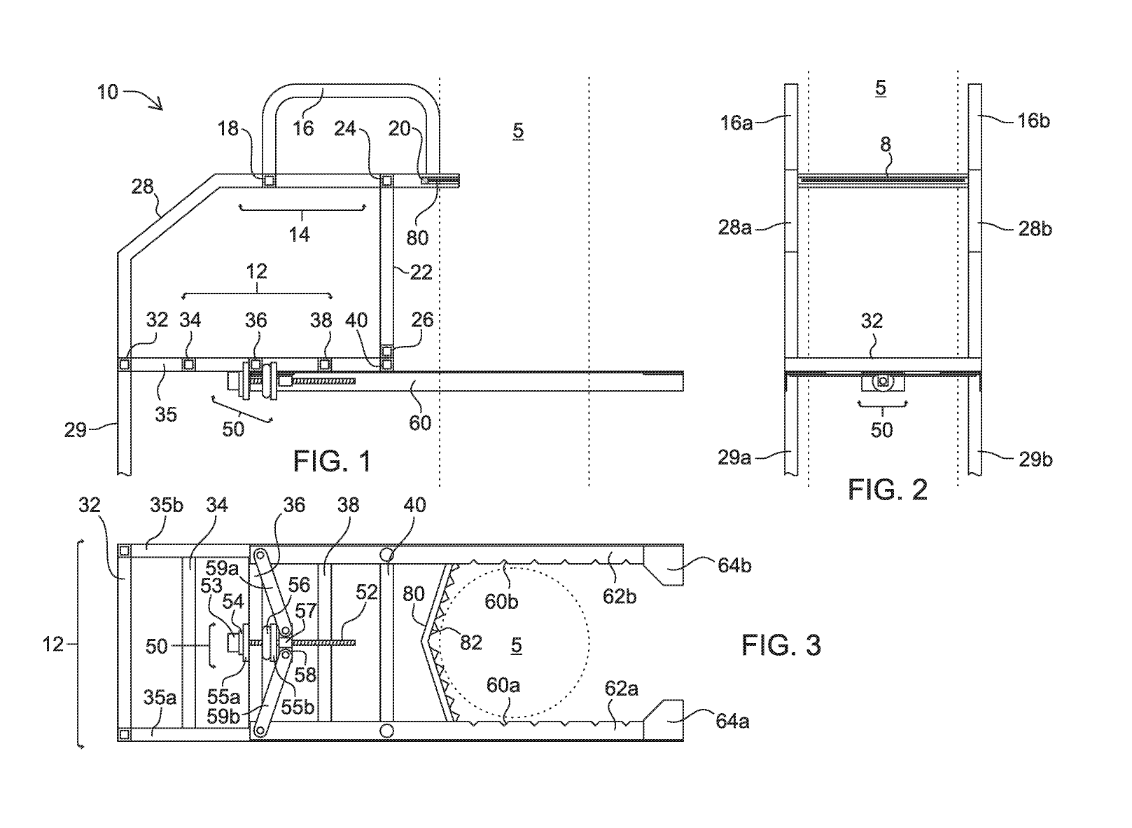

In an exemplary embodiment, shown in FIGS. 1 through 9, a novel tree stand is presented. The performance and safety benefits of the unique tree stand are accomplished by introducing a modified screw jack and clamp mechanism for bracing a tree, thereby establishing a strongly supported platform that minimizes risk to a user in ascending and descending, and resting upon, the tree stand.

The modified screw jack, or mechanical assemblage, is an ideal instrument for applying forced pressure upon a tree from ground level. A traditional jack amplifies a modest amount of force acted upon it into manipulating and supporting a heavy load. In the instant invention that force can be exerted well below the mechanical assemblage through the use of an extension rod. In turn, that force will drive a clamp into a tree trunk.

As a result of this design, an individual may stand at ground level, erect the ladder stand and securely anchor it to the tree before ascending alone or with accompanying gear to the platform. Specifically, a user would first ensure at ground level that the tree stand clamps are open, i.e. that the mechanical assemblage is released, or loosened, to an extent that the arms of the clamp are sufficiently turned outward to surround any particular tree trunk. The user would then elevate the tree stand by extending the supporting ladder to a desired height of use. Once the ladder has been extended, the user would position it against a tree where the base of the ladder is evenly and firmly standing upon the ground, and the platform clamp above is surrounding the proximate tree trunk. The user would finally extend a pole with socket up to the driver screw of the mechanical assemblage and crank the screw, i.e. tightening the screw and forcing the clamp arms inward to squeeze the tree trunk. Once the clamp is locked against the tree through this cranking mechanism, the user can freely ascend and descend the ladder to the platform above.

FIG. 1 presents a side view of the platform level 10 of the preferred embodiment. Here, a seat 14 is positioned directly above a deck, or elevated floor 12. Features of the seat may include arched handrails 16, and horizontal rungs 18, 24 that form the supporting structure for a pad or covering. The seat 14 is securely framed above the floor 12 by rungs 22 extending vertically above and below horizontal rung endpoints 24, 26. The seat 14 contacts the tree 5 through a rigid, jawbone shaped extension 80 that provides uppermost anchorage.

Similar to the seat 14 above, the floor 12 of the platform 10 is framed by horizontal rungs 32, 34, 36, 38, 40 that could support a pad or covering for standing or housing gear and supplies. A cavity between the seat 14 and floor 12 is framed on the sides by doglegged rails 28 that assist in transitioning between the platform 10 to ladder 29 below through assent and descent.

Underneath the floor is a modified screw jack, or mechanical assemblage 50, and clamp 60 system. Here, the assemblage 50 is presented in cross-sectional view.

FIG. 2 presents a frontal view of the platform from a position of ascent. Here, the assemblage 50 is seen mounted below the floor, represented by one of the horizontal rungs 32. The side architecture of the platform includes rails 28a, 28b and arms supports 16a, 16b below and above the seat, respectively, which is represented as a combination of the uppermost horizontal rungs and jawbone 8 in the foreground of the tree 5.

FIG. 3 presents an underside view of the platform, specifically detailing the mounting of the assemblage and clamp system. The floor 12 is represented by the horizontal rungs 32, 34, 36, 38, 40 framed by sidebars 35a, 35b. Mounted to the underside of a middle rung 36 is a mechanical assemblage 50 consisting of: a drive screw 52 that is manipulated or cranked by a drive nut 53; washers 54, 56; mounts 55a, 55b; and a main pivoting nut 57 connected to a base plate 58 that moves along the threads of the drive screw 52. Pivoting wings 59a, 59b connected to the base plate 58 push outwards extension arms 60a, 60b as the drive nut 53 turns the drive screw 52 and the nut 57 moves along the screw 52 towards the screw mount. As the wings 59a, 59b push connected ends of the extension arms 60a, 60b outwards, distal ends of the arms 64a, 64b are pushed inwards towards the tree 5 due to the mounting points on opposite ends of rung 40. The extensions act as a clamp upon a tree 5, with serrated edges 60a, 60b that can embed and lock into a tree trunk. Flanges on the clamps 64a, 64b minimize the space between the clamp ends and act as safeguards to prevent the tree stand from detaching completely away from the tree should the tree stand pull away from tree.

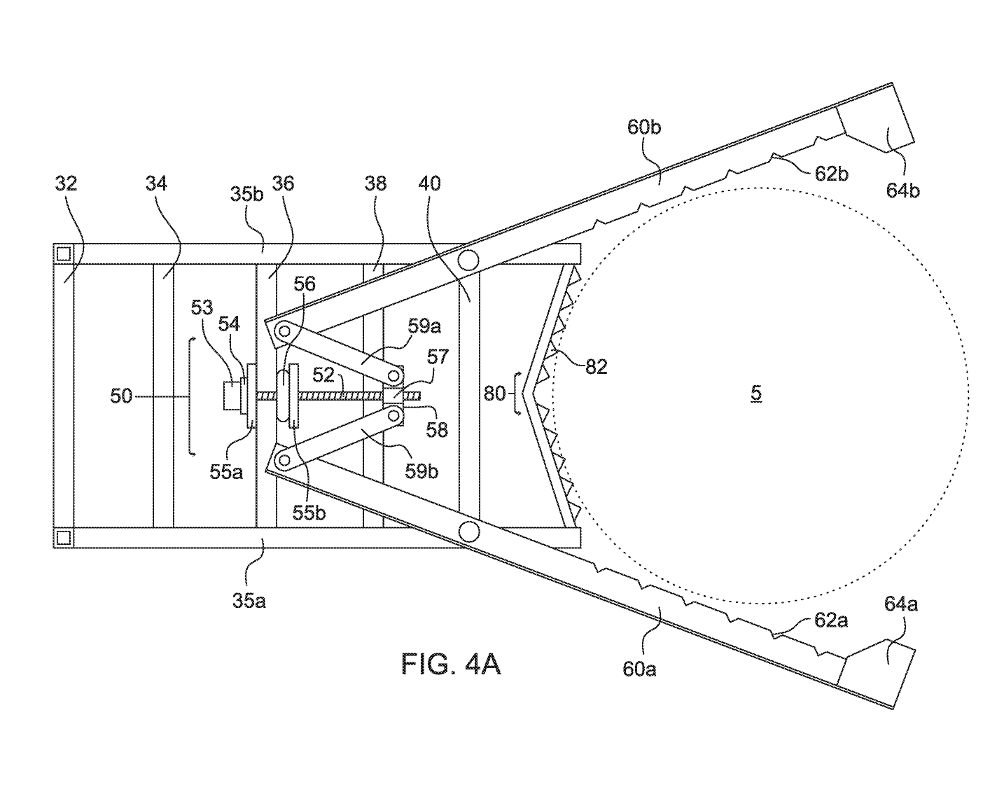

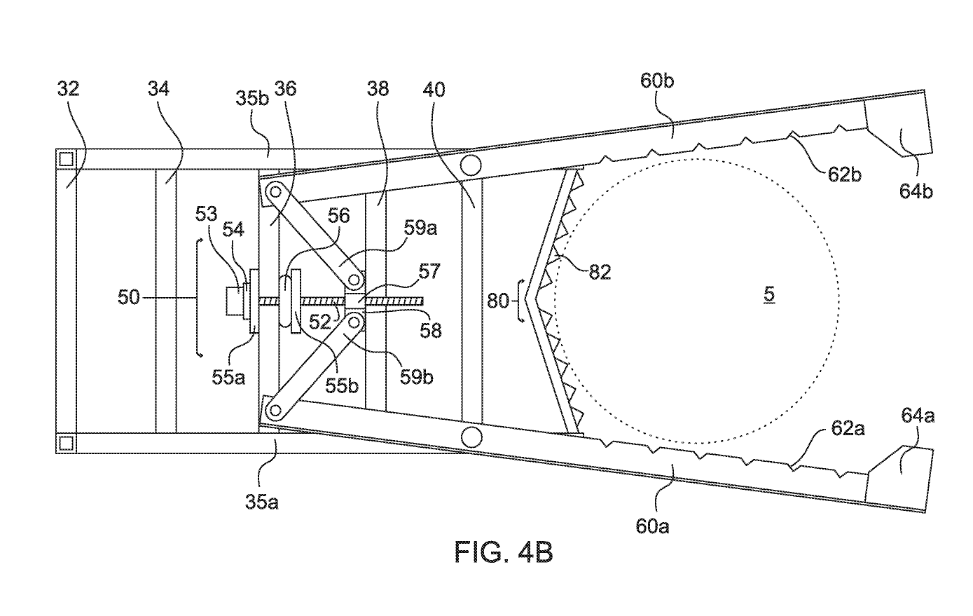

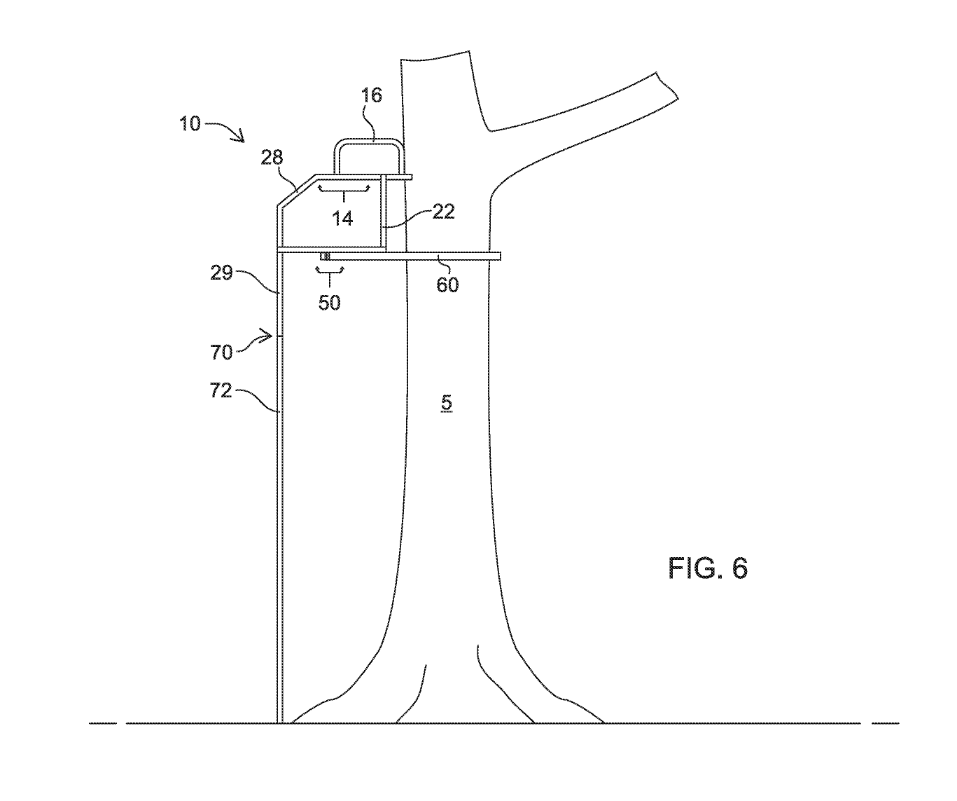

FIG. 4A presents an underside view of the platform in which the mechanical assemblage is in a maximally extended position. This is achieved by acting upon the drive screw 52 at a point distal to the point of clamp attachment 58, located at the drive nut 53. While the assemblage 50 is anchored to the platform at the underside of the middle rung 36, the pivoting nut 57 moves back and forth along the drive screw 52 as the drive screw is manipulated at the drive nut 53. This movement causes the proximate, connected ends of the extension arms 60a, 60b to move back and forth towards and away from the assemblage 50 by means of the pivoting wings 59a, 59b.

FIG. 4B presents the depiction of FIG. 4A acting upon a smaller diameter tree 5. Here, the drive screw 52 is turned such that the pivoting nut 57 is closer to the screw mount on 36, thereby pushing out the wings 59a, 59b and forcing the outermost portions of the extension arms 60a, 60b inward towards the tree, having fulcrum mounts at 40.

FIG. 6 presents a side view of a fully extended ladder connected with tree stand. Here, the platform 10 attaches at a point 70 to a supporting ladder 72.

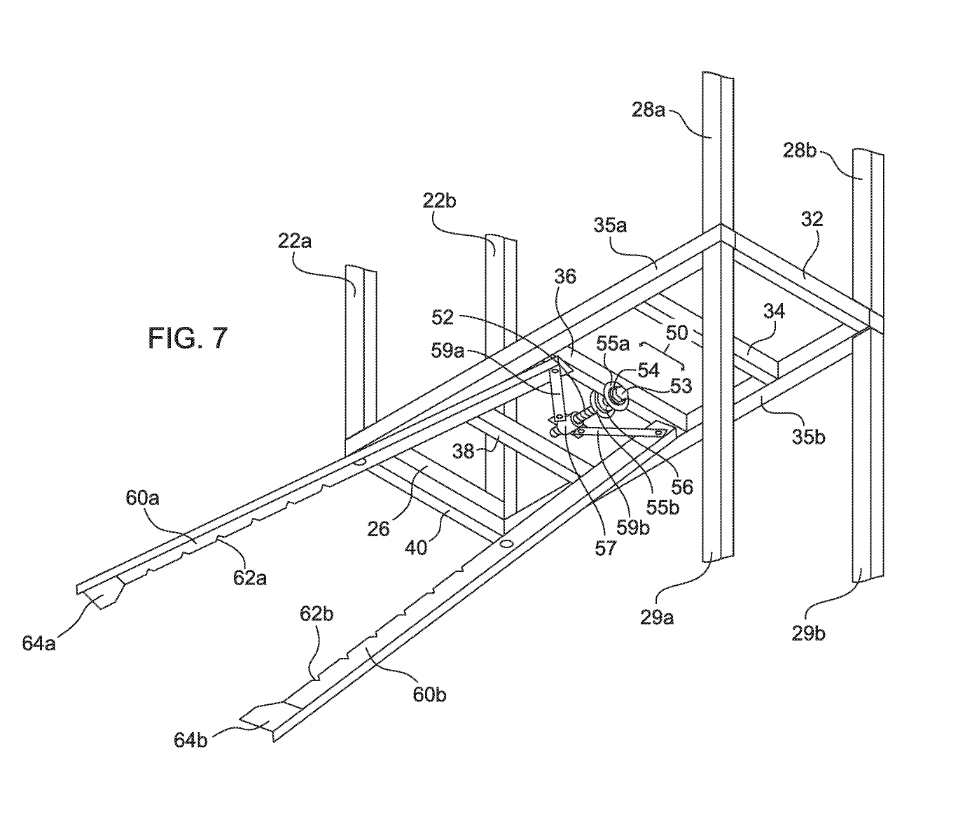

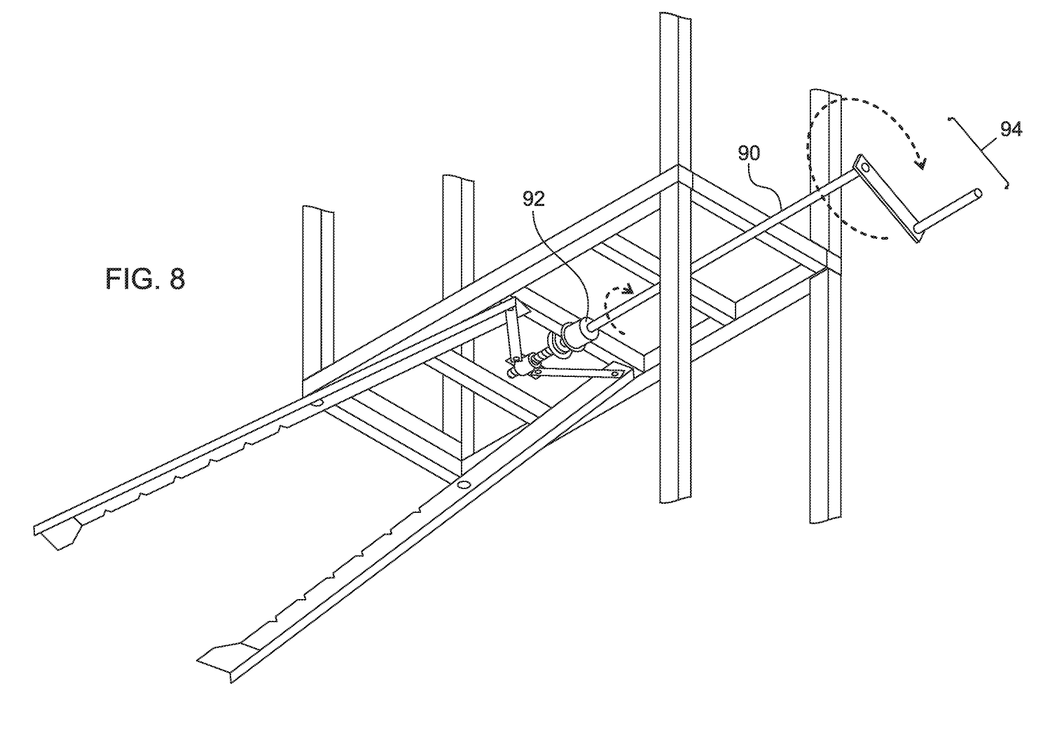

FIG. 7 presents an underside perspective view of the platform for the reader's benefit.

FIG. 8 presents an underside perspective view of the platform demonstrating a cranking activity of a horizontal rod 90 which is connected to the drive nut at socket connector 92.

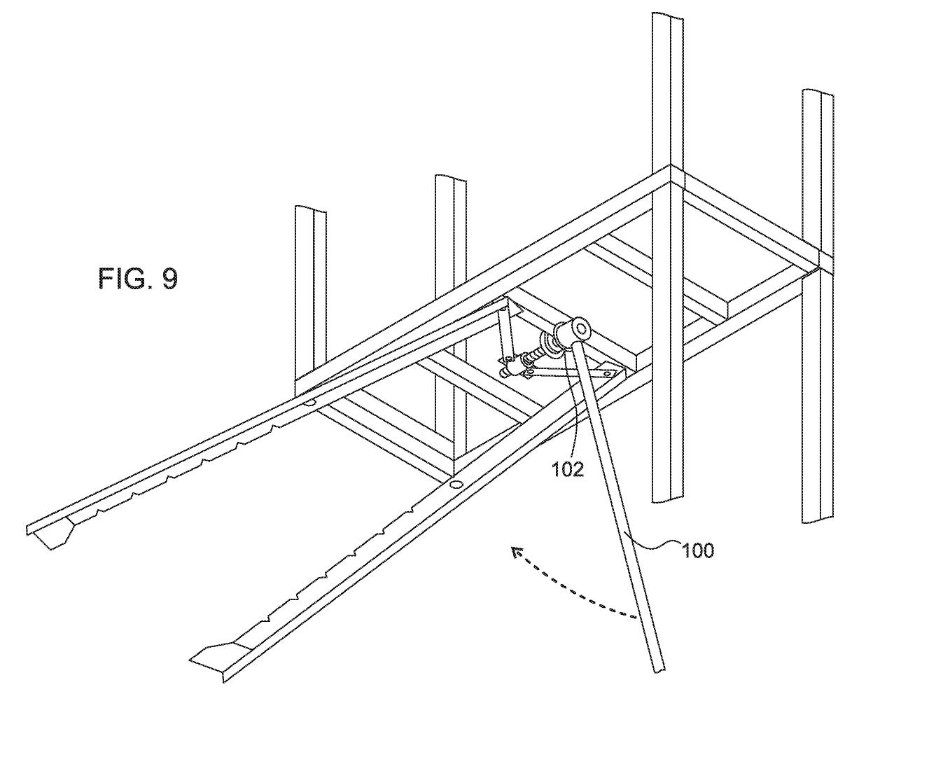

FIG. 9 presents an alternative underside perspective view of the platform demonstrating a cranking activity of a vertical rod 100 connected to the drive nut at socket connector 102. From a ground position, a user of the tree stand could extend a vertical rod with socket attachment upwards to a connecting point, and then through a side-to-side motion, turn the drive nut enabling the mechanical work described above and resulting in the clamp system tightly engaged and anchoring the tree.

I claim:

1) An apparatus for hunting or observational use from an elevated position, or tree stand, comprising:
a ladder;
a first platform connected to the ladder and extending towards a tree;
a mechanical system connected to the first platform;
at least one extension connected to the first platform and controlled by the mechanical system, with the ability to move towards and away from contact with the tree;
a second platform above the first platform; and
an anchor connected to the second platform extending towards the tree.

2) The apparatus of claim 1, wherein the anchor connected to the second platform contains a serrated side directed outwards towards the tree.

3) The apparatus of claim 1, wherein the mechanical system connected to the first platform further comprises a screw and is connected to the underside of the first platform.

4) The apparatus of claim 1, wherein the first platform and second platforms are further comprised of horizontal rungs.

5) A mechanical system connected to a tree stand, comprising:
a screw;
a means of turning said screw; and
a nut connected to said screw that can move along the threads of said screw.

6) The system of claim 5, wherein the screw is connected to one or more components that act upon a third component.

7) The system of claim 6, wherein the third component further comprises a rigid arm connected to the tree stand, and said arm features a serrated side and an end flange pointed in the direction of the serrated edge.

8) The system of claim 5, wherein said screw is connected to the underside of a tree stand and controls at least two serrated arms that extend outwards beyond the tree stand towards a tree.

9) The system of claim 8), wherein said arms are each connected to the tree stand and can away from and towards the tree in a clamping motion.
